(19) United States
(12) Patent Application Publication
(10) Pub. No.: US 2025/0173543 A1
(43) Pub. Date: May 29, 2025

(54) ITERATIVE PRUNING OF LAYERS, NODES, AND WEIGHTS FOR AN ARTIFICIAL NEURAL NETWORK

(71) Applicant: TOYOTA RESEARCH INSTITUTE, INC., Los Altos, CA (US)

(72) Inventors: Amalie E. TREWARTHA, San Francisco, CA (US); Weike YE, Sunnyvale, CA (US); Xiangyun LEI, Atlanta, GA (US)

(73) Assignees: TOYOTA RESEARCH INSTITUTE, INC., Los Altos, CA (US); TOYOTA JIDOSHA KABUSHIKI KAISHA, Aichi-Ken (JP)

(21) Appl. No.: 18/638,435

(22) Filed: Apr. 17, 2024

Related U.S. Application Data
(60) Provisional application No. 63/602,966, filed on Nov. 27, 2023.

(51) Int. Cl. G06N 3/04; G06N 3/08

(52) U.S. Cl. CPC G06N 3/04; G06N 3/08

(57) ABSTRACT

A method for pruning a neural network model includes iteratively removing, via structural pruning, one or more nodes and one or more layers of the neural network model. The method also includes removing, via weight pruning after the structural pruning, one or more weights of the neural network model by iteratively masking each connection of a group of connections with a smallest weight based on a respective absolute value of each connection.

### CROSS-REFERENCE TO RELATED APPLICATION

The present application claims the benefit of U.S. Provisional Patent Application No. 63/602,966, filed on Nov. 27, 2023, and titled “ITERATIVE PRUNING OF LAYERS, NODES, AND WEIGHTS FOR AN ARTIFICIAL NEURAL NETWORK,” the disclosure of which is expressly incorporated by reference in its entirety.

### BACKGROUND

### Field

Aspects of the present disclosure generally relate to artificial neural networks, and more specifically to systems and methods for iterative pruning of layers, nodes, and weights for an artificial neural network.

### Background

Machine learning (ML) is a subset of artificial intelligence (AI) focused on building systems that learn from data. Unlike traditional programming, where tasks are performed based on explicit instructions, machine learning models use statistical functions to enable software applications to improve their prediction, decision-making, or performance with experience or data. Machine learning has evolved over the years, diversifying into various types, including supervised learning, unsupervised learning, and reinforcement learning. Deep learning is a subset of machine learning characterized by layers of artificial neural networks. Inspired by the structure and function of the brain, these neural networks are designed to simulate the way humans think and learn. While traditional machine models become progressively better at whatever their function is, they still need some guidance. In deep learning, data is filtered through multiple layers of the network, which learn to identify features and attributes independently.

Active learning is a use case of machine learning where an active learning model can iteratively and interactively query the user (or some other information source) to obtain new data points. Active learning may be useful in scenarios where labeled data is scarce or expensive to obtain. In some cases, a surrogate model may be used during active learning. The surrogate model is an example of a simpler, often less computationally expensive model that approximates the behavior of a more complex model or system. In the context of neural networks, the surrogate neural network is designed to mimic the responses of a more complex or computationally demanding models/simulations. In some examples, the surrogate model acts as an intermediary between the complex model (or real-world system) and the active learning process. The surrogate model may be used to predict outcomes, analyze patterns, or perform other tasks that would be too costly or time-consuming for the more complex model to handle directly.

### SUMMARY

The present disclosure is set forth in the independent claims, respectively. Some aspects of the disclosure are described in the dependent claims.

In some aspects of the present disclosure, a method for pruning a neural network model includes iteratively removing, via structural pruning, one or more nodes and one or more layers of the neural network model. The method further includes removing, via weight pruning after the structural pruning, one or more weights of the neural network model by iteratively masking each connection of a group of connections with a smallest weight based on a respective absolute value of each connection.

Other aspects of the present disclosure are directed to an apparatus for pruning a neural network model. The apparatus includes means for iteratively removing, via structural pruning, one or more nodes and one or more layers of the neural network model. The apparatus further includes means for removing, via weight pruning after the structural pruning, one or more weights of the neural network model by iteratively masking each connection of a group of connections with a smallest weight based on a respective absolute value of each connection.

In other aspects of the present disclosure, a non-transitory computer-readable medium with program code recorded thereon for pruning a neural network model is disclosed. The program code is executed by a processor and includes program code to iteratively remove, via structural pruning, one or more nodes and one or more layers of the neural network model. The program code still further includes program code to remove, via weight pruning after the structural pruning, one or more weights of the neural network model by iteratively masking each connection of a group of connections with a smallest weight based on a respective absolute value of each connection.

Other aspects of the present disclosure are directed to an apparatus for pruning a neural network model. The apparatus includes one or more processors, and one or more memories coupled with the one or more processors and storing processor-executable code that, when executed by the one or more processors, is configured to cause the apparatus to iteratively remove, via structural pruning, one or more nodes and one or more layers of the neural network model. Execution of the instructions further cause the apparatus to remove, via weight pruning after the structural pruning, one or more weights of the neural network model by iteratively masking each connection of a group of connections with a smallest weight based on a respective absolute value of each connection.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram illustrating an example of a system for accelerated learning that includes one or more surrogate models, in accordance with aspects of the present disclosure.

FIG. 2 is a diagram illustrating an example of a hardware implementation for a system, in accordance with aspects of the present disclosure.

FIG. 3 is a diagram illustrating an example of a pruning process, in accordance with various aspects of the present disclosure.

FIG. 4 is a diagram illustrating an example of a block pruning function, in accordance with various aspects of the present disclosure.

FIG. 5 is a diagram illustrating an example of a layer and node pruning function, in accordance with various aspects of the present disclosure.

FIG. 6 is a diagram illustrating an example of a weight pruning function, in accordance with various aspects of the present disclosure.

FIG. 7 is a flow diagram illustrating an example of a process for pruning a model, in accordance with some aspects of the present disclosure.

### DETAILED DESCRIPTION

The detailed description set forth below and in Appendix A, in connection with the appended drawings, is intended as a description of various configurations and is not intended to represent the only configurations in which the concepts described herein may be practiced. The detailed description include specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be broadly applicable to different technologies, system configurations, networks, and protocols, some of which are illustrated by way of example in the figures and in the following description of the preferred aspects. The detailed description and the drawings are merely illustrative of the present disclosure rather than limiting, the scope of the present disclosure being defined by the appended claims and equivalents thereof.

Deep learning is a subset of machine learning characterized by layers of artificial neural networks. Inspired by the structure and function of the brain, these neural networks are designed to simulate the way humans think and learn. While traditional ML models become progressively better at whatever their function is, they still need some guidance. In deep learning, data is filtered through multiple layers of the network, which learn to identify features and attributes independently.

One factor in the effectiveness of deep learning is a size of the model. For example, larger models necessitate more computational power for both training and operation, potentially restricting their practical use. Additionally, increasing a number of parameters in the model may improve flexibility. However, increasing the number of parameters may lead to overfitting, thereby impeding the model's ability to generalize well to new, unseen data. Generalization may be useful when the model is expected to make predictions about unexplored regions of the data space.

Various pruning techniques may be used to reduce the size of the model. Conventional pruning techniques include, but are not limited to, weight pruning, node (e.g., neuron) pruning, structured pruning, dynamic network surgery, iterative pruning, the lottery ticket hypothesis, and autoML for model compression. Each of these pruning techniques has its merits and drawbacks, and each pruning technique often caters to different aspects of the pruning problem. Still, conventional systems are often limited to only using one of the pruning techniques. It may be desirable to use a comprehensive pruning approach that capitalizes on the strengths of these various pruning techniques while mitigating their weaknesses.

Various aspects of the present disclosure are directed to reducing the size of a model via a hierarchical pruning protocol. In some examples, the pruning protocol uses layer pruning, node pruning, and weight pruning. The integration of layer pruning, node pruning, and weight pruning, distinguishes the pruning protocol from conventional pruning functions. In such examples, the three pruning functions may be integrated into a single, iterative process, which is in contrast to conventional pruning functions that often engage in a more random exploration of potential network architectures. In some examples, the pruning process yields an untrained model as an output, allowing for initial pruning on extensive, publicly available datasets. This pruned, yet untrained model can then be re-trained with smaller, specific datasets.

Particular aspects of the subject matter described in this disclosure can be implemented to realize one or more of the following potential advantages. In some examples, the described techniques of iterative pruning using layer pruning, node pruning, and weight pruning provide more comprehensive pruning in comparison to conventional pruning process. The comprehensive pruning reduces the size of the model, such that the model may be re-trained and deployed as needed in a variety of tasks, such as active learning.

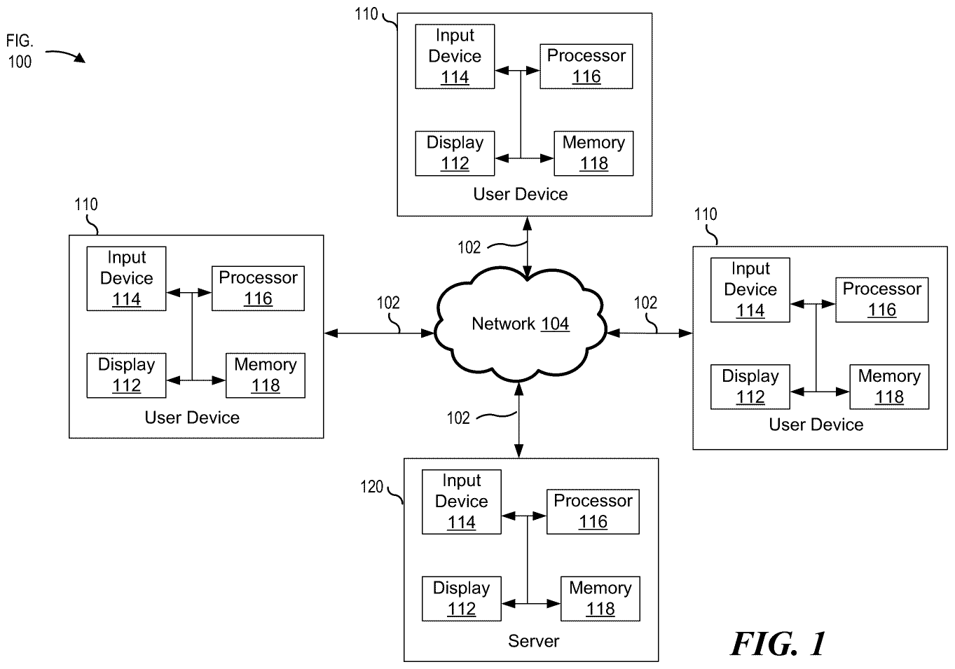

FIG. 1 is a block diagram illustrating an example of a system 100 for accelerated learning that includes one or more surrogate models, in accordance with aspects of the present disclosure. As shown in the example of FIG. 1, the system 100 may include one or more user devices 110 and one or more servers 120. For ease of explanation, only one server 120 is shown in the example of FIG. 1. Each user device 110 may be connected to a network 104 via one or more communication links 102. The communication links 102 may be wired and/or wireless communication links. The server 120 may also be connected to the network 104 via a communication link 102.

The network 104 may be an example of the Internet. Additionally, or alternatively, the network 104 may include any suitable computer network such as an intranet, a wide-area network (WAN), a local-area network (LAN), a wireless network, a digital subscriber line (DSL) network, a frame relay network, an asynchronous transfer mode (ATM) network, and/or a virtual private network (VPN). The communication links 102 may be any type of communication link that may be suitable for communicating data between user devices 110 and the server 120. For example, the communication links 102 may include one or more of network links, dial-up links, wireless links (e.g., Wi-Fi link, satellite link, or cellular communication link), and/or hard-wired links.

The server 120 may be a computing device, such as a server, processor, computer, cloud computing device, cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to host a generative AI model and communicate via a wireless or wired medium. In some examples, the server 120 may host a generative AI model. In some such examples, one or more server 120 may work in tandem to host the generative AI model. Specifically, the server 120 may implement functions and/or computer code that runs the generative AI model and/or a site, such as a website, for accessing the generative AI model.

Each user device 110 may be an example of a personal computing device, a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium. A user device 110 may be used by a user to input a prompt to a generative AI model via an interface associated with the generative AI model. The interface may be accessed via a website or a dedicate application, such as a mobile phone application. Additionally, or alternatively, the user device 110 may store the generative AI model, and the user may input a prompt via an interface associated with the stored generative AI model. In some examples, each user device 110 shown in FIG. 1 may be used by a different user. Each user device 110 and server 120 may be stationary or mobile.

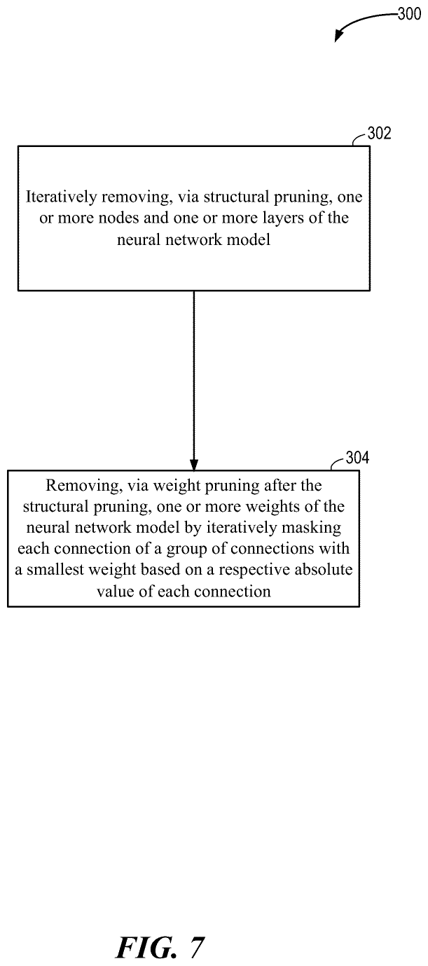

In some examples, each user device 110 may be included inside a housing that houses components of the user device 110, such as one or more processors 116 and a memory 118. The housing may also include, or be connected to, a display 112 and an input device 114, which may be interconnected with other components of the user device 110. For ease of explanation, only one processor 116 is shown for each user device 110. In some examples, the one or more processors 116, the display 112, the input device 114, and the memory 118 may be interconnected via a bus architecture. The memory 118 may include one or more different types of memory, such as random access memory (RAM), static RAM (SRAM), dynamic RAM (DRAM), and/or another type of memory. Each user device 110 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the user device 110. The input device 114 may be used to navigate the interface associated with the surrogate model, and/or perform other tasks. Working in conjunction with one or more components of the user device 110, the processor 116 may receive information associated with the surrogate model, and control the display 112 to output information associated with the surrogate model. The display 112 may output (e.g., display) information received at the processor 116. In some examples, the processor 116 of the user device 110 is configured to perform operations and implement one or more elements associated with one or more processes, such as the process 700 described with respect to FIG. 7.

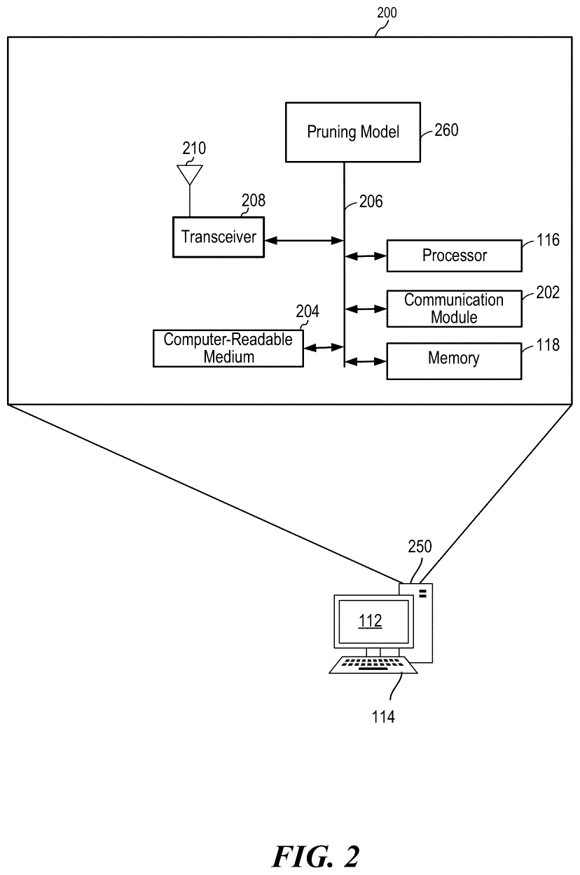

In some examples, a server 120 may be included inside a housing that houses components of the server 120, such as one or more processors 116 and a memory 118. The housing may also include, or be connected to, a display 112 and an input device 114, which may be interconnected with other components of the user device 110. For ease of explanation, only one processor 116 is shown for the server 120. In some examples, the one or more processors 116, the display 112, the input device 114, and the memory 118 may be interconnected via a bus architecture. The memory 118 may include one or more different types of memory, such as RAM, SRAM, DRAM, and/or another type of memory. The server 120 may also include a storage device (not shown in the example of FIG. 1), such as a hard disk (e.g., non-transitory computer readable medium). In some examples, the memory 118 and/or the storage device include program code (e.g., instructions) that may be executed by the processor 116 to control one or more functions of the server 120. For example, the processor 120 may execute instructions for maintaining the surrogate model, training the surrogate model, and/or executing the surrogate model. In some examples, the processor 116 of the server 120 is configured to perform operations and implement one or more elements associated with one or more processes, such as the process 700 described with respect to FIG. 7. Additionally, or alternatively, the processor 116 of the server 120 may be configured to perform operations associated with the pruning model 260 described with reference to FIG. 2.

FIG. 2 is a diagram illustrating an example of a hardware implementation for a system 200, according to various aspects of the present disclosure. The system 200 may be a component of a device 250. The device 250 may be an example of a user device 110 or a server 120 described with reference to FIG. 1. As shown in the example of FIG. 2, the device 250 may include a display 112 and an input device 114 (e.g., a keyboard). In some examples, the system 200 is configured to perform operations and implement one or more elements associated with one or more processes, such as the process 700 described with respect to FIG. 7.

The system 200 may be implemented with a bus architecture, represented generally by a bus 206. The bus 206 may include any number of interconnecting buses and bridges depending on the specific application of the system 200 and the overall design constraints. The bus 206 links together various circuits including one or more processors and/or hardware modules, represented by a processor 116, and a communication module 202. The bus 206 may also link various other circuits such as timing sources, peripherals, voltage regulators, and power management circuits, which are well known in the art, and therefore, will not be described any further.

The system 200 includes a transceiver 208 coupled to the processor 116, the communication module 202, and the computer-readable medium 204. The transceiver 208 is coupled to an antenna 210. The transceiver 208 communicates with various other devices over a transmission medium, such as a communication link 102 described with reference to FIG. 1. For example, the transceiver 208 may receive commands via transmissions from a user or a remote device.

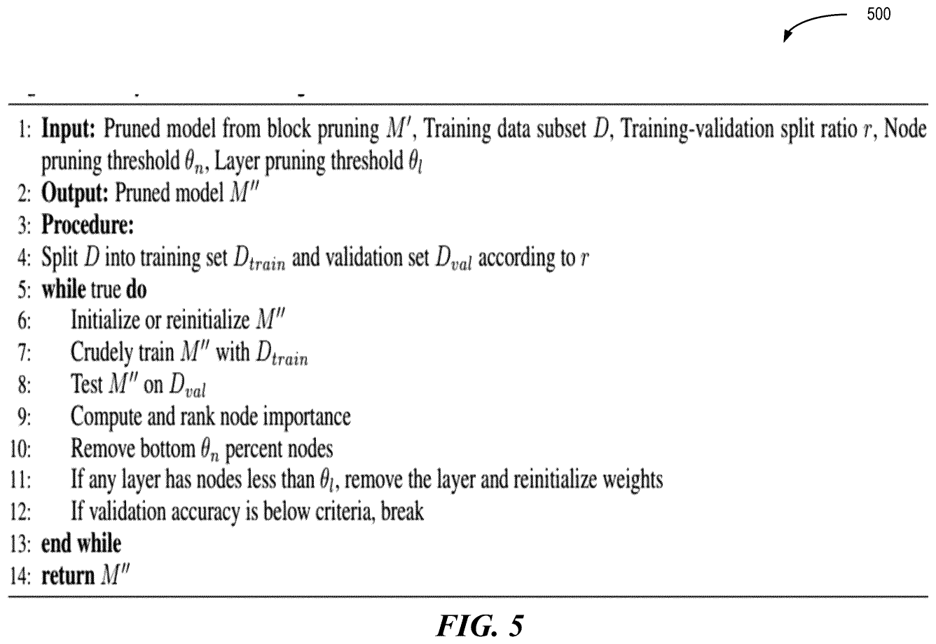

As shown in the example of FIG. 2, the system 200 may include a pruning model 260 that may be trained to perform one or more tasks associated with accelerating a surrogate model. For example, the pruning model 260 may be trained to perform the tasks described with reference to the one or more modules and engines described with reference to FIG. 5. The pruning model 260 may include artificial or computational intelligence elements, such as, neural network, fuzzy logic, or other machine learning algorithms. In one or more arrangements, one or more of the other modules 116, 118, 202, 204, 208, can also include artificial or computational intelligence elements, such as, neural network, fuzzy logic, or other machine learning algorithms. Further, in one or more arrangements, one or more of the modules 116, 118, 202, 204, 208 can be distributed among multiple modules 116, 118, 202, 204, 208, 260 described herein. In one or more arrangements, two or more of the modules 116, 118, 202, 204, 208, 260 of the system 200 can be combined into a single module.

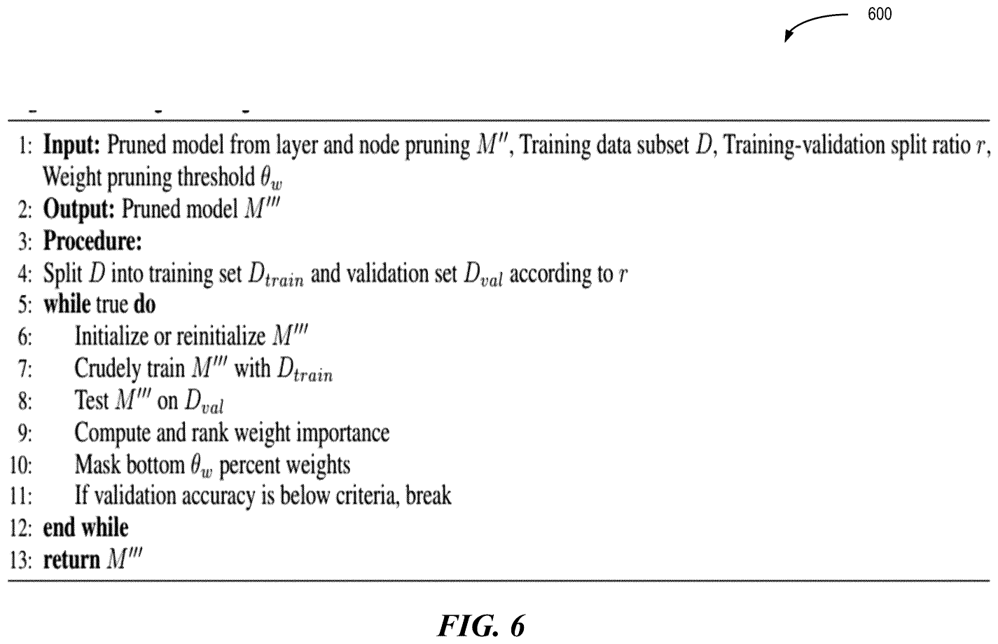

The system 200 includes the processor 116 coupled to the computer-readable medium 204. The processor 116 performs processing, including the execution of software stored on the computer-readable medium 204 providing functionality according to the disclosure. The software, when executed by the processor 116, causes the system 200 to perform the various functions described for a particular device, such as any of the modules 116, 118, 202, 204, 208, 260. For example, when executed by the processor 116, the software causes the system 200 and/or the pruning model 260 to implement one or more elements associated with one or more processes, such as the process 600 described with respect to FIG. 6. The computer-readable medium 204 may also be used for storing data that is manipulated by the processor 116 when executing the software. For example, working in conjunction with one or more of the other modules the modules 116, 118, 202, 204, and 208, the pruning model 260 may perform one or more operations, such as the operations of the process 700 described with reference to FIG. 7.

In some examples, the system 200 may include one or more of the modules 116, 118, 202, 204, 208, and 260 described with reference to FIG. 2. For example, the system 200 may include one or more processors 116 and one or more memories 118.

As indicated above, FIGS. 1 and 2 are provided as examples. Other examples may differ from what is described with regard to FIGS. 1 and 2.

As discussed, various pruning techniques may be used to reduce the size of the model. Conventional pruning techniques include, but are not limited to, weight pruning, node pruning, structured pruning, dynamic network surgery, iterative pruning, the lottery ticket hypothesis, and autoML for model compression. Node pruning may also be referred to as neuron pruning, wherein a node is an example of a neuron.

Weight pruning is a process where individual weights in a model are removed based on their magnitude, leading to sparse weight matrices. These matrices can be beneficial when utilizing sparse matrix computation techniques. However, weight pruning may not change a size of the weight matrix. In some cases, a mask may be used for the weight pruning. In such cases, an additional matrix is specified to store the mask without changing the actual weight matrices. Therefore, weight pruning may not improve acceleration . . . .

Node pruning (e.g., neuron pruning), on the other hand, addresses the issue of irregular sparsity patterns by removing entire nodes, thus creating a model with fewer connections and structured sparsity. Remove entire an entire node results in the removal of corresponding rows and columns of related weight matrices, thereby, reducing a size of the weight matrices and improving acceleration, such as computational acceleration. This makes node pruning more compatible with hardware accelerators. However, node pruning's impact on reducing computational cost and memory footprint is more significant compared to weight pruning, because node pruning reduces the size of weight matrices.

Structured pruning, also known as filter pruning, strikes a balance by removing convolutional filters or channels within a layer. This approach reduces both the model's depth and width while maintaining a structured data format, making the model highly compatible with existing hardware. However, structured pruning typically relies on the magnitude of filter weights or their sum for pruning decisions. Therefore, structured pruning may not always be optimal, as it can overlook the overall network structure.

Dynamic network surgery (DNS) presents a more advanced technique, combining pruning and splicing (re-adding pruned connections) to dynamically adjust the model's structure during training. DNS allows for more aggressive pruning without significantly compromising performance, though it adds complexity to the process.

Iterative pruning follows a train-prune-retrain cycle. After initial training, the model undergoes pruning and is then fine-tuned. This process is repeated to achieve the desired level of sparsity. While this approach enables the model to regain performance lost in pruning, iterative pruning also lengthens the overall training duration.

The Lottery Ticket hypothesis posits that smaller subnetworks within larger networks (e.g., models) can, when trained independently, perform as well or better than the original network. This hypothesis is guiding the development of more effective pruning techniques that aim to discover these “winning tickets.”

Lastly, AutoML for model compression (AMC) represents an automated pruning approach. AMC uses reinforcement learning to determine the best pruning strategy, thereby eliminating the need for practitioners to manually tune the pruning process.

Various aspects of the present disclosure are directed to reducing the size of a model via a hierarchical pruning protocol. In some examples, the pruning protocol uses block pruning, layer pruning, node pruning, and weight pruning. The integration of block pruning, layer pruning, node pruning, and weight pruning, distinguishes the pruning protocol from conventional pruning functions. In such examples, the pruning functions may be integrated into a single, iterative process, which is in contrast to conventional pruning functions that often engage in a more random exploration of potential network architectures.

In some examples, the pruning process yields an untrained model as an output, allowing for initial pruning on extensive, publicly available datasets. This pruned, yet untrained model can then be re-trained with other datasets. Although the pruning process generates a smaller and sparser model, the accuracy of the generated model may be comparable (e.g., within a threshold accuracy) to the un-pruned model. In some examples, the pruning process begins with an untrained model. The objective of the pruning process is to transform this initial model into an optimized structure that is better suited for an intended task. In some examples, weights of the pruned model may be extracted to seed-optimized models in subsequent training phases, potentially enhancing the efficiency and effectiveness of the training process.

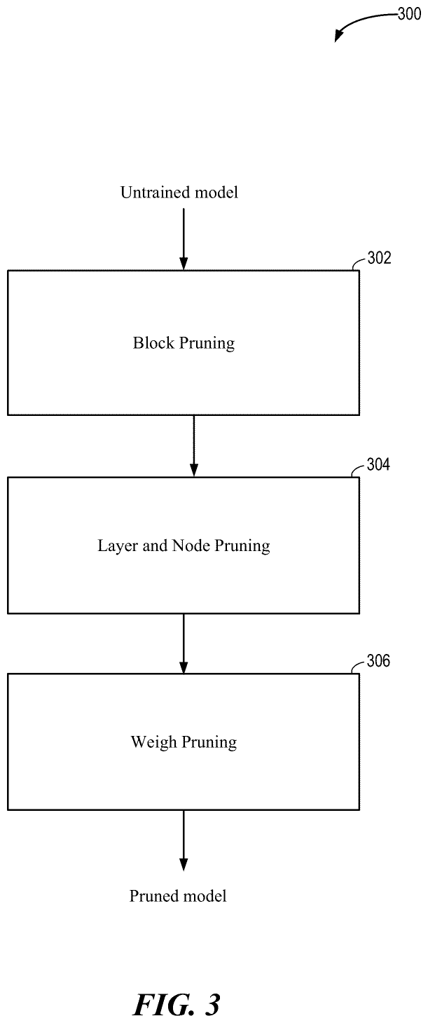

FIG. 3 is a diagram illustrating an example of a pruning process 300, in accordance with various aspects of the present disclosure. The pruning process 300 may be performed by the pruning model 260 described with reference to FIG. 2. The pruning process 300 may include a block pruning stage 302, a layer and node pruning stage 304, and a weight pruning stage 406.

In the example of FIG. 3, an untrained model may be input to a block pruning stage 302. The purpose of the block pruning stage 302 is to eliminate blocks that contribute minimally to the model's learning capability, thereby simplifying the model. This simplification can lead to various benefits, such as faster training times, reduced memory usage, and potentially better generalization by preventing overfitting.

Block pruning may be specified for optimizing graph-based machine learning models, particularly focusing on models that use message-passing mechanisms, such as graph neural networks (GNNs). Still, block pruning may be used for other types of neural networks.

The block pruning process may evaluate and remove certain blocks from the network to streamline the model. In a neural network, such as a GNN, a block may refer to a segment of the network responsible for message passing. Message passing is a process where nodes in the network exchange information. The message passing may be used by the neural network to learn and make predictions based on the graph structure.

In some examples, a decision to remove a block may be based on the weight values within that block. Weights in neural networks are examples of parameters that determine the strength of the connection between nodes. In block pruning, the block pruning function assesses either the mean (e.g., average) or the maximum of absolute values of these weights in each block. Absolute values are used to ensure that the decision is based on the magnitude of the weights, irrespective of their positive or negative sign.

If this calculated mean or maximum value falls below a pre-defined threshold, the block is considered for removal. This threshold may specify the sensitivity of the pruning process. Setting the threshold too low might result in excessive pruning, potentially degrading the model's performance. Conversely, a high threshold may lead to insufficient pruning, not adequately reducing the model's complexity.

In the example of FIG. 3, the block pruning stage 302 outputs a first pruned model. The output of the block pruning stage 302 may be received at a layer and node pruning stage 304. Layer and node pruning is a technique designed for optimizing one or more fully connected layers of a machine learning model.

The layer and node pruning stage 304 begins by dividing a subset of the training data into distinct training and validation sets. Following the random initialization of weights, the model undergoes a phase of crude training using the training set and is then evaluated on the validation set. Based on the crude training result, the significance of each node is assessed and ranked based on the mean or maximum absolute value of their outgoing connections. Nodes deemed to be of lower importance are then pruned from the model. Moreover, if the pruning results in a layer having fewer nodes than a specified threshold, that layer is entirely removed from the model, necessitating the re-initialization of weights for the remaining structure. This pruning process is iteratively repeated until a point where the accuracy on the validation set drops below a pre-defined standard, signaling the completion of the pruning phase. The layer and node pruning stage 304 streamlines the model by eliminating less critical nodes and layers, thereby enhancing its overall efficiency and performance.

The layer and node pruning stage 304 outputs a second pruned model. The output of the layer and node pruning stage 304 may be received at a weight pruning stage 306. Weight pruning is an example of an optimization technique that applies to all parts of a machine learning model, extending beyond just the fully connected layers.

The weight pruning stage 306 follows a similar methodology to node and layer pruning stage 304 but focuses on the individual weights within the model. The significance of each weight is determined by its absolute value, identifying how crucial the weight is to the model's performance. Weights deemed less important may be masked or effectively ignored in the model's computations. The process at weight pruning stage 306 continues iteratively until reaching a point where the model's accuracy on the validation set decreases to a pre-defined threshold. At this juncture, the pruning process halts, ensuring that the model retains its essential predictive capabilities while eliminating redundant weights to improve efficiency. The weight pruning stage 306 outputs a third pruned model (shown as pruned model in the example of FIG. 3).

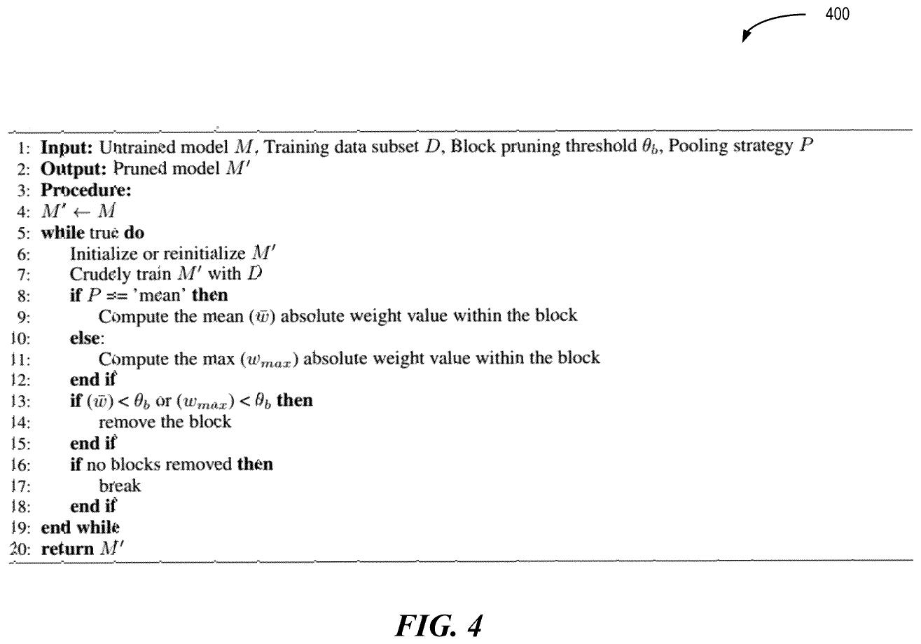

FIG. 4 is a diagram illustrating an example of a block pruning function 400, in accordance with various aspects of the present disclosure. The block pruning function 400 may be implemented at a block pruning stage 302 described with reference to FIG. 3. As shown in the example of FIG. 4, the block pruning function receives, as input, an untrained model, a training data subset, a block pruning threshold, and a pooling strategy, which can be either mean or max. An output of the block pruning function 400 is a first pruned model.

Initially, the first pruned model s may be set (e.g., initialized or re-initialized) to the untrained model. The block pruning function 400 is an iterative process. Each iteration starts with initializing or reinitializing the first pruned model, such that the first pruned model is in a suitable state for pruning. Following this, the first pruned model undergoes a crude training phase using the training data subset.

A crude training phase is an example of a preliminary and simplified training process aimed at establishing a basic understanding of a model's functionality. In contrast to full training, which seeks to maximize model performance through extensive iterations and comprehensive data utilization, crude training is brief and uses a simplified approach and/or a subset of the data. The goal is not to fully optimize the model but to identify potential improvements or areas for reduction, particularly useful in pruning processes to determine which parts of the model are less essential for its predictive capabilities. That is, the crude training phase is not intended to fully train the model but to identify which blocks can be pruned.

After the crude training phase, the block pruning function 400 assesses the weights within each block of the first pruned model, based on a selected pooling strategy. If the mean is selected (‘mean’), the block pruning function 400 calculates the mean absolute weight value within each block. Conversely, if max is selected, the block pruning function 400 computes the maximum absolute weight value within each block. The decision to prune a block is based on these calculated values-if either the mean absolute weight value or the maximum absolute weight value is less than a threshold below the threshold (or), the block pruning function 400 identifies the block as a candidate for removal. The block may be removed when identified as a removal candidate.

The absolute weight value within a block refers to the magnitude of the weights without regard to their sign (positive or negative). A weight in a neural network represents the strength of the connection between two neurons, influencing how the signal is transmitted from one neuron to another within the network. These weights can have positive or negative values, indicating the nature of their effect (excitatory or inhibitory) on the signal being passed. In a block of a neural network (e.g., model), which may be a grouping of neurons or layers designed for a specific function (such as a convolutional block in a convolutional neural network or a message-passing block in a graph neural network), the absolute weight value is used to measure the importance or influence of these connections without considering the direction of their influence. This is done by taking the absolute value of each weight, essentially converting all weights to their non-negative form.

In the example of FIG. 4, the pruning loop continues until an iteration occurs where no blocks are removed, indicating that all blocks that could be pruned without compromising the threshold criterion have been eliminated. This termination check may prevent over-pruning, ensuring that the model retains its essential characteristics. Finally, the block pruning function 400 concludes by outputting the first pruned model. The result is a streamlined version of the untrained model.

FIG. 5 is a diagram illustrating an example of a layer and node pruning function 500, in accordance with various aspects of the present disclosure. The layer and node pruning function 500 may be implemented at a layer and node pruning stage 304 described with reference to FIG. 3. As shown in the example of FIG. 5, the layer and node pruning function 500 receives, as input, the first pruned model from the block pruning stage, such as the block pruning stage 302 described with reference to FIG. 3. The layer and node pruning function 500 may also receive, as input, the training data subset, a node pruning threshold, a layer pruning threshold, and a training-validation split ratio. An output of the layer and node pruning function 500 is a second pruned model.

As shown in the example of FIG. 5, initially, the training data subset is divided into a training set and a validation set in accordance with the training-validation split ratio. The layer and node pruning function 500 then initiates an iterative process, wherein the second pruned model is either initialized or reinitialized to start from a baseline state. In some examples, the second pruned model is re-initialized as the first pruned model. Then, the second pruned model may be crudely training with the training set to identify expendable nodes without fully optimizing performance. After the crude training, the second pruned model is evaluated on the validation set to assess performance on unseen data. This evaluation assists in computing and ranking an importance of each node, leading to the removal of the least important nodes, defined as those in the bottom percent of nodes (e.g., less than the percent node pruning threshold). Should this pruning result in any layer having fewer nodes than the layer pruning threshold, that layer is removed, and the model's weights are reinitialized. This iterative process may repeat until the validation accuracy drops below a set criterion, signaling that further pruning could harm the model's effectiveness. The procedure concludes with the second pruned model, which may be an example of a model refined for efficiency by removing superfluous nodes and layers.

FIG. 6 is a diagram illustrating an example of a weight pruning function 600, in accordance with various aspects of the present disclosure. The weight pruning function 600 may be implemented at a weight pruning stage 306 described with reference to FIG. 3. As shown in the example of FIG. 6, the weight pruning function 600 receives, as input, the first second pruned model from the weight stage, such as the weight stage 304 described with reference to FIG. 3. The weight pruning function 600 may also receive, as input, the training data subset, a node pruning threshold, a weight pruning threshold, and the training-validation split ratio. An output of the weight pruning function 600 is a third pruned model.

As shown in the example of FIG. 6, initially, the training data subset is divided into a training set and a validation set in accordance with the training-validation split ratio. The weight pruning function 600 then initiates an iterative process, wherein the third pruned model is either initialized or reinitialized to start from a baseline state. In some examples, the third pruned model may be re-initialized to the second pruned model Then, the third pruned model may be crudely training with the training set to identify expendable nodes without fully optimizing performance. After the crude training, the third pruned model is evaluated on the validation set to assess performance on unseen data. This evaluation assists in computing and ranking an importance of each weight, leading to the masking the least important weight, defined as those in the bottom percent of weights (e.g., less than the weight pruning threshold). This iterative process may repeat until the validation accuracy drops below a set criterion. The procedure concludes with the third pruned model.

In some examples, the pruning process includes two parts: structural pruning (e.g., block, node, and layer pruning) and weight pruning. Structural pruning focuses on the architecture of the model, streamlining the model by selectively removing blocks, layers, and/or nodes. The structural pruning may maintain or improve overall network performance. Such pruning effectively decreases the number of trainable parameters, thereby reducing the training cost.

As discussed, the pruning process is iterative. In some examples, the pruning process may begin with a fully-sized neural network model with randomly seeded connection weights. After training with a specific training dataset, the importance of each node is assessed based on metrics, such as mean or maximum outward connection weight. Less important nodes, identified based on a user-defined ratio, are then pruned. If a layer's node count falls below a certain threshold, the entire layer is removed. This cycle of training, assessing, and pruning is repeated until a condition is satisfied, such as an increase in test set error. Notably, each iteration begins with the network's weights reset to their original seed values, which are only re-calculated if a layer is removed.

Weight pruning, while also iterative, targets the connections between nodes. The weight pruning begins with a fully connected neural network model with seeded weights and involves a more rudimentary initial training phase. After this, connections with the smallest weights are masked, effectively pruning them from the network. The process continues, with the model undergoing testing after each pruning iteration, until there's a noticeable rise in error on the test set. Similar to structural pruning, weight pruning also resets the network's weights to their original seed values at the beginning of each iteration.

Both pruning functions—structural and weight—work in tandem to enhance the model's performance. Structural pruning reduces the complexity and size of the model, leading to lower training costs, potentially faster processing, and reduced memory usage. Weight pruning, which may trim less significant connections, improves the model's ability to generalize and prevent overfitting, making it more data-efficient. Together, these pruning techniques offer a systematic and effective approach to refining and optimizing neural network architectures, enhancing their efficiency and efficacy.

After the pruning process, the model has fewer nodes and fewer active connections, making it faster and less resource-intensive to run. This optimized model is now well-suited for the active learning task of improving the energy efficiency of industrial machines, executing faster and using fewer computational resources.

The field of material science has made advancements based on developments in artificial intelligence (AI) and machine learning (ML). The field of material science is a complex area, which requires the understanding and manipulation of materials at different scales. Conventional material science procedures often encounter challenges with traditional experimental and computational methods, especially in dealing with vast and intricate parameter spaces and nonlinear characteristics. Machine learning, particularly adept at identifying patterns in extensive datasets and making precise predictions, has become a valuable tool in addressing these challenges.

Deep learning, an essential branch of machine learning, has been extensively applied in materials informatics. Some deep learning models may be based on a multilayer perceptron (MLP). These models use designed embeddings of materials. Examples of such models include, but are not limited to, a Gaussian multipole (GMP) feature-based MLP model and a smooth overlap of atomic positions (SOAP) feature-based MLP. Some other deep learning models are graph neural networks (GNNs) which use graph representations to express topological relationships in molecules and crystals. GNNs operate on a graph domain, gathering information from the local surroundings through the exchange of messages between the nodes and edges of the graphs.

In some cases, active learning is used in the field of material sciences. Active learning is a use case of machine learning (e.g., deep learning) where an active learning model can interactively query a user (or some other information source) to obtain new data points to learn from. Active learning may be useful in scenarios where labeled data is scarce or expensive to obtain. In some cases, a surrogate model may be used during active learning. The surrogate model is an example of a simpler, often less computationally expensive model that approximates the behavior of a more complex model or system. In the context of neural networks, the surrogate neural network is designed to mimic the responses of a more complex or computationally demanding model. In some examples, the surrogate model acts as an intermediary between the complex model (or real-world system) and the active learning process. The surrogate model may be used to predict outcomes, analyze patterns, or perform other tasks that would be too costly or time-consuming for the more complex model to handle directly.

In an active learning process, the surrogate model may be used to navigate a complex landscape of parameter space. The surrogate model, known for its computational affordability, may serve as an initial hypothesis generator. For example, the surrogate model may propose areas within the parameter space that might yield insightful results. Subsequently, these hypotheses are tested through more resource-intensive experiments or high-fidelity computations. The aim here is to either validate or refute the initial assumptions made by the surrogate model.

In an ideal scenario, the outcomes of these experiments or computations are not the end but a means to further refine the surrogate model. This iterative process involves using the results to fine-tune the surrogate model, thereby enhancing its accuracy and predictive capabilities. As the surrogate model's performance improves, it becomes more adept at proposing new and more precise hypotheses for exploration.

However, some challenges exist because re-training and/or fine-tuning surrogate models on a regular basis, a necessity in active learning, becomes computationally expensive. This limitation constrains the surrogate model's ability to continuously integrate new data and feedback from experiments, potentially hindering its effectiveness in hypothesis generation. Furthermore, the large number of parameters in neural network models can impede their ability to generalize well to new, unseen data. Generalization may be useful when the model is expected to make predictions about unexplored regions of the parameter space.

In a conventional active learning setup for material discovery, the user begins by defining a target, which is the property that needs to be optimized. Next, the user provides a pool of potential materials, known as the search space. Within this pool, some materials will already have known properties—these constitute the seed data. The user also needs to choose the architecture for a surrogate model, which acts as the agent. This surrogate model is designed to predict the properties of materials when the surrogate model is adequately trained. The campaign may begin with the surrogate model being trained on the seed data. The surrogate model then uses this training to predict the properties of the other materials in the candidate pool. Based on these predictions, and according to user-defined criteria, a batch of materials is selected for experimental testing. The results from these tests are then added back into the seed data, enriching the database for subsequent iterations. This entire cycle repeats until either the surrogate model has explored all possible candidates or a predetermined limit of experiments has been reached.

The most resource-intensive aspect of these active learning campaigns typically involves the regular re-training of the surrogate model after each new set of experimental data is added. Neural networks are often the preferred choice for the surrogate model due to their exceptional learning capabilities. However, these neural network models use significant amounts of data for training and are known for being computationally demanding.

Various aspects of the present disclosure are directed to accelerating the re-training process and reducing the size of machine learning models, such as surrogate models. Such aspects may be universally applicable across various neural network architectures. In some examples, a pre-training phase is specified to leverage existing large-scale general-purpose databases. By using such comprehensive datasets, the neural network is provided with a broad foundational knowledge base.

This foundational pre-training equips the surrogate model with a more robust framework for making predictions. As a result, the surrogate model can more effectively guide the selection of future experiments. The enhanced predictive power of the surrogate model, coupled with its improved sample efficiency, marks a significant advancement in the field of active learning. The various aspects of the present disclosure not only streamline the active learning process but also expand the potential of neural network models as efficient and accurate surrogate models in various research and application domains.

As discussed, in some examples, three pruning functions may be specified: layer pruning, node pruning, and weight pruning. The integration of the three pruning functions into an iterative, systemic process is novel, as is the application to active learning. Specifically, the use of three pruning functions (layer, node, and weight) into a cohesive, single iterative process is distinct from conventional systems. Some conventional systems rely on a more random exploration of potential network architectures. The systematic nature of the various aspects of the present disclosure simplifies the optimization process and improves its efficiency.

Additionally, in contrast to some other conventional systems, an untrained model is produced as an output of the pruning process of the current disclosure. As such, the initial pruning may be performed on large, publicly available datasets. The pruned, yet untrained, model can subsequently be trained from scratch using smaller, research-specific datasets. This feature is particularly beneficial for active learning campaigns, where an optimized neural network architecture can be pre-prepared and then efficiently trained with data acquired during the campaign.

Additionally, various aspects of the present disclosure introduce a hierarchical integration of layer, node, and weight pruning. This hierarchical structure results in more comprehensive pruning capabilities. Notably, layer pruning often leads to the most significant computational speed-ups, positioning the current approach as substantially more efficient compared to existing technologies.

The various aspects of the present disclosure are an improvement over conventional active learning processes, where neural networks, due to their extensive parameter sets, face challenges in regular re-training and generalization. By integrating a pre-training phase using large, general-purpose databases, aspects of the present disclosure accelerate the re-training process of neural network models and reduce their size. This improvement facilitates a more dynamic and responsive adaptation of the surrogate model in the active learning cycle. As such, the surrogate model may efficiently incorporate new data and feedback from experiments, thus improving its predictive accuracy and hypothesis generation capabilities. Additionally, the reduction in surrogate model size achieved improves the model's ability to generalize to new, unseen data, thereby increasing the overall sample efficiency and robustness of the system in various research and application contexts. Specifically, improvements in the data efficiency and training speed of these surrogate models can improve the effectiveness of active learning campaigns. Enhancing these aspects allows for a more rapid and efficient discovery of materials with the desired properties within the search space.

In some examples, a preliminary pruning process is applied to the surrogate model. This pruning process may enhance the data efficiency and training speed of the model. Notably, the pruning process may be implemented during the campaign, particularly before re-training the agent model with new data.

This modified approach to active learning may reduce a total number of iterations, and the models may be re-trained faster in each iteration, in comparison to conventional active learning systems. An additional advantage of this method is the automated optimization of the neural network architecture of an agent model. This removes the need for labor-intensive and expert-driven hyperparameter optimization, further streamlining the process and reducing associated costs. As a result, the integration of this pruning process in the active learning campaign for material discovery represents a substantial advancement, enhancing the efficiency and reducing the time specified to identify materials with the desired properties.

FIG. 7 is a flow diagram illustrating an example process 700 for pruning a model, in accordance with some aspects of the present disclosure. The pruning may be performed by a pruning model 260 described with reference to FIG. 2. The neural network model may be a fully connected neural network model. Additionally, the neural network model may be a surrogate model. Furthermore, the surrogate model may be used in an active learning process.

As shown in FIG. 7, the process 700 begins at block 702 by iteratively removing, via structural pruning, one or more nodes and one or more layers of the neural network model. Each of the one or more nodes may be removed based on a respective mean or respective maximum outward connection weight. The structural pruning is performed at each iteration of a group of structural pruning iterations. In some examples, the process 700 also includes resetting network weights to seed values at each iteration of the group of structural pruning iterations. The seed values may be re-calculated after removing the one or more layers. In some examples, the neural network model is trained on a training dataset after each iteration of the group of structural pruning iterations. Additionally, the neural network model is tested on a test dataset after each iteration of the group of structural pruning iterations. The structural pruning may be repeated until an increase in a test set error value. In some examples, each layer of the one or more layers is removed based on a respective number of nodes associated with the layer being less than a node threshold.

At block 704 the process 700 removes, via weight pruning after the structural pruning, one or more weights of the neural network model by iteratively masking each connection of a group of connections with a smallest weight based on a respective absolute value of each connection. The weight pruning may be performed at each iteration of a group of weight pruning iterations. In some examples, the neural network model may be trained on a training dataset after each iteration of the group of weight pruning iterations. Additionally, in such examples, the neural network model may be tested on a test dataset after each iteration of the group of weight pruning iterations. In some examples, un-pruned weights may be re-set to seed values at a beginning of each iteration of the group of weight pruning iterations. In some examples, the weight pruning may be repeated until an increase in a test set error.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine-readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functions described throughout this present disclosure. Those skilled in the art will recognize how best to implement the described functionality for the processing system depending on the particular application and the overall design constraints imposed on the overall system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for pruning a neural network model, comprising:
iteratively removing, via structural pruning, one or more nodes and one or more layers of the neural network model; and
removing, via weight pruning after the structural pruning, one or more weights of the neural network model by iteratively masking each connection of a group of connections with a smallest weight based on a respective absolute value of each connection.

2. The method of claim 1, wherein each of the one or more nodes is removed based on a respective mean or respective maximum outward connection weight.

3. The method of claim 1, wherein the structural pruning is performed at each iteration of a group of structural pruning iterations, and the method further comprises resetting network weights to seed values at each iteration of the group of structural pruning iterations.

4. The method of claim 3, further comprising:
training the neural network model on a training dataset after each iteration of the group of structural pruning iterations; and
testing the neural network model on a test dataset after each iteration of the group of structural pruning iterations.

5. The method of claim 4, wherein the structural pruning is repeated until an increase in a test set error value.

6. The method of claim 3, further comprising re-calculating the seed values after removing the one or more layers.

7. The method of claim 1, wherein each layer of the one or more layers is removed based on a respective number of nodes associated with the layer being less than a node threshold.

8. The method of claim 1, wherein the neural network model is a fully connected neural network model.

9. The method of claim 1, wherein the weight pruning is performed at each iteration of a group of weight pruning iterations, and the method further comprises:
training the neural network model on a training dataset after each iteration of the group of weight pruning iterations; and
testing the neural network model on a test dataset after each iteration of the group of weight pruning iterations.

10. The method of claim 9, further comprising resetting un-pruned weights to seed values at a beginning of each iteration of the group of weight pruning iterations.

11. The method of claim 9, further comprising repeating the weight pruning until an increase in a test set error.

12. The method of claim 1, wherein the neural network model is a surrogate model.

13. The method of claim 12 wherein the surrogate model is used in an active learning process.

14. An apparatus for pruning a neural network model, comprising:
one or more processors; and
one or more memories coupled with the one or more processors and storing processor-executable code that, when executed by the one or more processors, is configured to cause the apparatus to:
iteratively remove, via structural pruning, one or more nodes and one or more layers of the neural network model; and
remove, via weight pruning after the structural pruning, one or more weights of the neural network model by iteratively masking each connection of a group of connections with a smallest weight based on a respective absolute value of each connection.

15. The apparatus of claim 14, wherein each of the one or more nodes is removed based on a respective mean or respective maximum outward connection weight.

16. The apparatus of claim 14, wherein the structural pruning is performed at each iteration of a group of structural pruning iterations, and execution of the processor-executable code further causes the apparatus to reset network weights to seed values at each iteration of the group of structural pruning iterations.

17. The apparatus of claim 16, wherein the structural pruning is repeated until an increase in a test set error value.

18. The apparatus of claim 14, wherein each layer of the one or more layers is removed based on a respective number of nodes associated with the layer being less than a node threshold.

19. The apparatus of claim 14, wherein:
the weight pruning is performed at each iteration of a group of weight pruning iterations; and
execution of the processor-executable code further causes the apparatus:
to train the neural network model on a training dataset after each iteration of the group of weight pruning iterations; and
to test the neural network model on a test dataset after each iteration of the group of weight pruning iterations.

20. A non-transitory computer-readable medium having program code recorded thereon for pruning a neural network model, the program code executed by one or more processors and comprising:
program code to iteratively remove, via structural pruning, one or more nodes and one or more layers of the neural network model; and
program code to remove, via weight pruning after the structural pruning, one or more weights of the neural network model by iteratively masking each connection of a group of connections with a smallest weight based on a respective absolute value of each connection.
